(19) United States
(12) Patent Application Publication
(10) Pub. No.: US 2014/0348147 A1
(43) Pub. Date: Nov. 27, 2014

(54) POWER DISTRIBUTION UNIT FOR WIRELESS NETWORK TOPOLOGY AND DISTRIBUTION METHOD THEREOF

(71) Applicant: Li-Chun LAI, New Taipei City (TW)

(72) Inventor: Li-Chun LAI, New Taipei City (TW)

(21) Appl. No.: 13/902,352

(22) Filed: May 24, 2013

(51) Int. Cl. H04W 48/16; G05F 1/66

(52) U.S. Cl. CPC H04W 48/16; G05F 1/66
USPC 370/338

(57) ABSTRACT

A power outlet control device for a wireless network topology has a power input interface unit, a power switch control unit, a wireless network interface unit, a central process unit, a memory unit, and a power output unit. The power input interface unit connects with an outer power source. The power switch control unit distributes and controls the power from the input interface unit. The power output unit further outputs power to an outer system and control the power of the outer system.

### BACKGROUND OF THE INVENTION

1. Field of the Invention

The present invention generally relates to a power distribution unit for a wireless network topology and a distribution method thereof, more particularly to a power distribution unit (PDU) that enhances operations and convenience at home and provides a mechanism that lets multiple PDUs be connected with each other through an existing wireless network technology, but still keep the operational convenience.

2. Description of the Prior Art

Internet development by leaps and bounds, a wireless network can be described as the mainstream of the network around the world. No matter academia or industry, they have invested a lot of manpower to research in the fields. The market size of the wireless network is expanding at breakneck speed. Hence, how to develop more innovative and exclusive products for compatibility and functionality is superb, in order to compete in the fierce market place, attaches great importance to one of the topics for today academia or industry.

For the wireless access point (hereinafter referred to as AP), it provides the services of a general wireless station (hereinafter referred to as STA), and the services gradually unable to meet the general needs of the users, and so does enterprise-class users. Therefore, how to enhance the function of the AP in order to let different AP be connected with each other through a wireless distribution system (hereinafter referred to as WDS), and even become the part of the backbone of the network equipment, so it is an excellent direction of development. WDS is part of the 802.11 standard, the standard in the basic network architecture (infrastructure) can be interconnected to each other, the AP can be used to extend to the range of the wireless network. Traditionally, different APs connecting to each other in the WDS must manually set the media access control (hereinafter referred to MAC) address, in order to decide to create a physical link meshing topology between the AP s, but the topology is not only inelastic, its structure is fixed and not extendable. In addition, if one of the APs is offline or shutdown (power off), it may cause the collapses of the entire wireless network topology or loop, so that the entire domain communication causes problems. Since present WDS has no complete standard in operations, and some of the WDS cannot be very efficient in conjunction with existing Ethernet, and even under the condition of not considering the case of a wired network, the network topology construction is also very complicated, and without elasticity.

In addition, general power supply of prior server is to use power distribution unit (PDU) to distribute external AC power to each server, and then by the server's power adapter, AC is converted to DC for supplying power to the server. PDU is able to connect with the server, therefore if the characteristics of the PDU can be kept, and a mechanism is proposed to let multiple PDUs be connected with each other through an existing wireless network technology, and when a PDU is set and successfully connect to the Internet, the PDU will become a new wireless network hotspot at home. When another PDU appears, the wireless network hotspot of can be connected with the Internet, and hence it is to easily distribute a wireless network topology.

### SUMMARY OF THE INVENTION

The present invention provides a power distribution unit for a wireless network topology and a distribution method thereof, and it is to enhance operations and convenience of the power distribution unit (PDU) at home, and provides a present wireless network technology for plural PDUs to connect with each other, but still has operational convenience.

The present invention provides the power distribution unit for the wireless network topology and the distribution method thereof, and it is able to let a plurality of PDUs be connected with each other through wireless network communication means. While a PDU is set up and connect with the Internet, the PDU becomes a new wireless network hotspot of a home. While another PDU appears, the another PDU may automatically connect with the Internet through the new wireless network hotspot of the first PDU, so as to easily distribute the wireless network topology.

To reach above objectives of the power distribution unit for the wireless network topology and the distribution method thereof, the power distribution unit used for the wireless network topology comprises: a power input interface unit, which connects with an outer power source for providing power; a power switch control unit, which connects with the power input interface unit for distributing and control the power from the input interface unit; a wireless network interface unit, which at least connects with an network sharing device with a service set identifier; a central process unit, which connects with the power switch control unit and the wireless network interface unit, the central process unit comprises: an automatic searching network module, which connects with the wireless network interface unit for searching the network sharing device around the power distribution unit and driving the wireless network interface unit to connect with the network sharing device nearest the wireless network interface unit; a coding control module, which connects with the automatic searching network module for coding the service set identifier of the network sharing device that connects with the wireless network interface unit; a wireless network sharing module, which connects with the wireless network interface unit and the coding control module, the wireless network sharing module treats the coded service set identifier as a wireless network identifier, and makes the power distribution unit to engage in wireless hotspot network share through the wireless network interface unit; a disconnection judgment module, which connects with the wireless network interface unit and the automatic searching network module in order to determine whether the wireless network interface unit continuously engages in wireless connection, if no, the automatic searching network module is driven to search and connect with the network sharing device around the automatic searching network module; a memory unit, which connects with the central process unit and is able to store data information set by the central process unit; and a power output unit, which connects with the power switch control unit in order to output power to an outer system and control the power of the outer system.

In practice, the present invention further comprises a time counting unit, which connects with the central process unit for controlling a power output time and an automatic disconnection redetection time.

In practice, the wireless network sharing module having the coded service set identifier is a wireless base station or other power distribution units.

In practice, the wireless base station is able to connect with an outer network.

In practice, the present invention further comprises a remote control device that connects with the wireless base station and the power distribution unit for remote control through the outer network.

In practice, the present invention further engages in the wireless hotspot network share and searches the shared wireless network via other power distribution unit, and connect with the wireless network identifier through a coded service set identifier.

A method for distributing a wireless network topology comprises the steps of:
1. any of other power distribution units of a wireless network shared by a wireless base station that is searchable being connected with via a service set identifier set by the wireless base station, while a user activates the wireless base station and a power distribution unit;
2. the power distribution unit further coding the service set identifier set by the wireless base station to become a first class service set identifier;
3. providing the first class service set identifier to other power distribution units for wireless network connection, while the power distribution unit engages in wireless hotspot network share;
4. the other power distribution units further coding the first class service set identifier down to the next level of service set identifier; and
5. the power distribution unit that disconnects with a network automatically coding the service set identifier down to the next level of service set identifier, while the power distribution unit that disconnects with the network connects with another power distribution unit having the wireless hotspot network share.

In practice, if the power distribution unit connecting with a network detects the disconnection of the power distribution unit and the network, the power distribution unit automatically search the wireless base station or the power distribution unit around, and codes the service set identifier set by the connected wireless base station or the connected power distribution unit down to the next level of service set identifier.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A illustrates a schematic outer structural view of the power outlet control device for a wireless network topology and a distribution method of the present invention;

FIG. 1B illustrates a schematic whole structural view of the power outlet control device for the wireless network topology and the distribution method of the present invention;

FIG. 1C illustrates a schematic structural view of a central process unit of the power outlet control device for the wireless network topology and the distribution method of the present invention;

FIG. 2A illustrates a schematic view of a first preferred embodiment of the power outlet control device for the wireless network topology and the distribution method of the present invention;

FIG. 2B illustrates a schematic view of a second preferred embodiment of the power outlet control device for the wireless network topology and the distribution method of the present invention;

FIG. 2C illustrates a schematic view of a third preferred embodiment of the power outlet control device for the wireless network topology and the distribution method of the present invention;

FIG. 2D illustrates a schematic view of a fourth preferred embodiment of the power outlet control device for the wireless network topology and the distribution method of the present invention; and

FIG. 3 illustrates a flow chart of the power outlet control device for the wireless network topology and the distribution method of the present invention.

### DETAILED DESCRIPTION OF THE INVENTION

Following preferred embodiments and figures will be described in detail so as to achieve aforesaid objects.

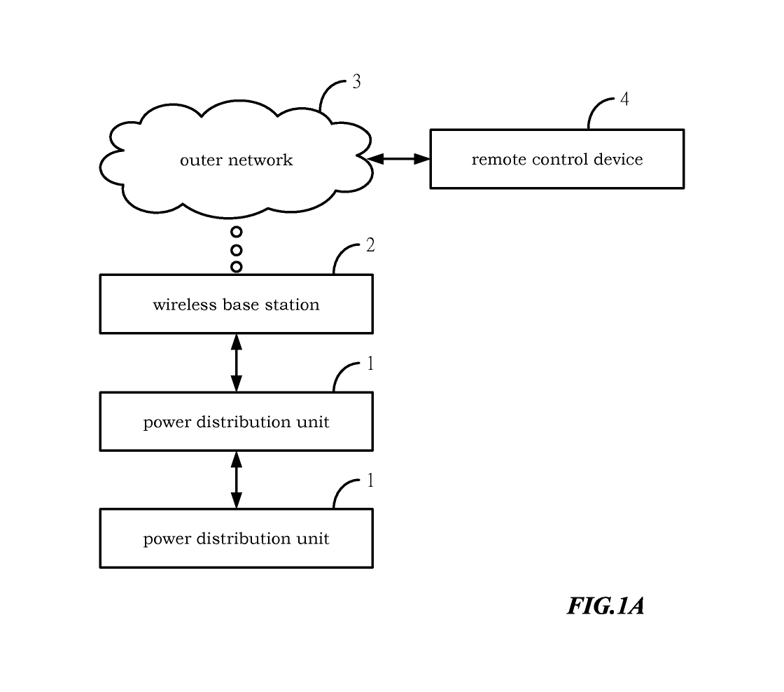

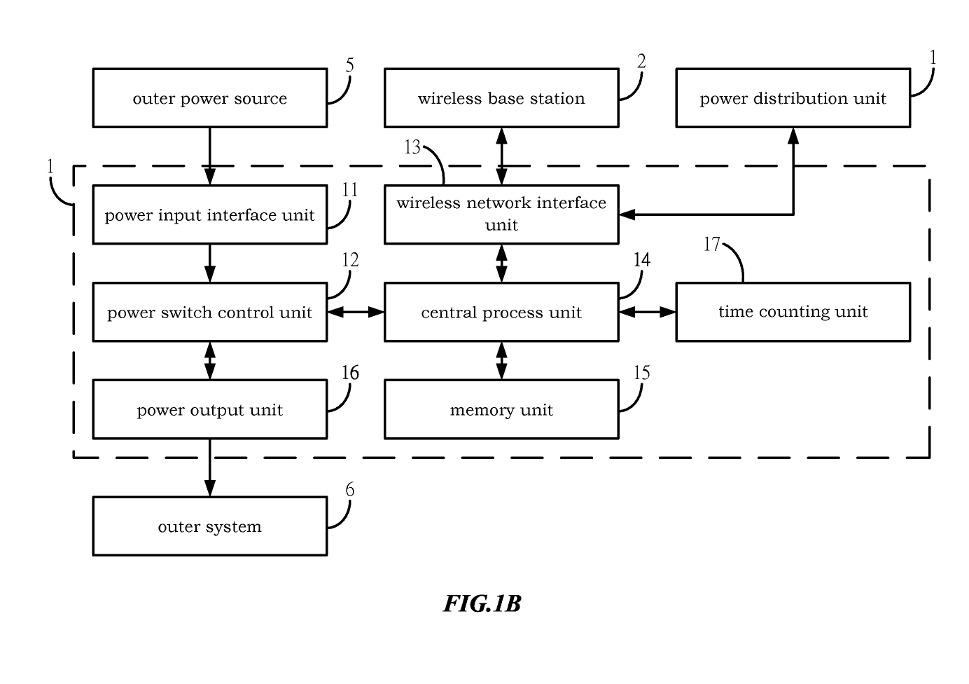

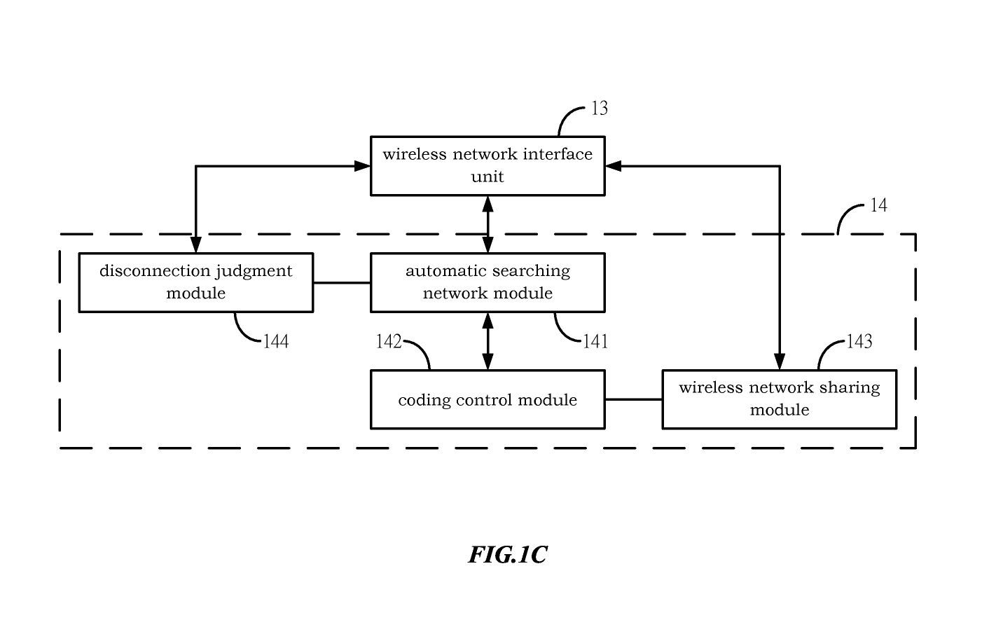

Please refer to FIG. 1A, FIG. 1B and FIG. 1C, which illustrate a schematic outer structural view of the power outlet control device for a wireless network topology and a distribution method of the present invention, a schematic whole structural view of the power outlet control device for the wireless network topology and the distribution method of the present invention, and a schematic structural view of a central process unit of the power outlet control device for the wireless network topology and the distribution method of the present invention. As shown in figure, the power outlet control device 1 has a power input interface unit 11, a power switch control unit 12, a wireless network interface unit 13, a central process unit 14, a memory unit 15, and a power output unit 16. The power input interface unit 11 connects with an outer power source 5. The power switch control unit 12 distributes and controls the power from the input interface unit 11. The power output unit 16 further outputs power to an outer system 6 and control the power of the outer system 6.

The wireless network interface unit 13 of the power outlet control device 1 is able to connect with a network sharing device. The network sharing device of the present invention is a wireless base station 2 or another power outlet control device 1. While the network sharing device connects with the wireless base station 2, that is through the connection of the wireless base station 2 and an outer network 3, so a remote control device 4 can be used. Through the outer network 3, the wireless base station 2 is entered and the power outlet control device 1 is also connected for remote controlling the power outlet control device 1. The power outlet control device 1 further engages in wireless hotspot network share. So, while another power outlet control device 1 searches a wireless network shard by the power outlet control device 1, the wireless network may be connected for wireless hotspot network share.

The central process unit 14 has an automatic searching network module 141, a coding control module 142, a wireless network sharing module 143, and a disconnection judgment module 144. While the power outlet control device 1 is activated, the network sharing device as the wireless base station 2 or another power outlet control device 1 adjacent to the power outlet control device 1 is searched, and the wireless network interface unit 13 is driven to connect with the nearest network sharing device. Since the wireless network interface unit 13 may log in a service set identifier while in connection, the service set identifier of the connected network sharing device is coded down to the next level of service set identifier by the coding control module 142, and the set data information may then be stored in the memory unit 15.

After coding, via the wireless network sharing module 143, the coded service set identifier can be as a wireless network identifier. Through the wireless network interface unit 13, the power outlet control device 1 is able to engage in wireless hotspot network share. In addition, to avoid the collapse of the disconnection of any power outlet control device 1 of the network topology, the disconnection judgment module 144 may periodically determine whether the wireless network interface unit 13 continuously engage in wireless connection. If no, it means disconnection, and therefore the automatic searching network module 141 may be automatically driven to search and connect with a network sharing device nearby.

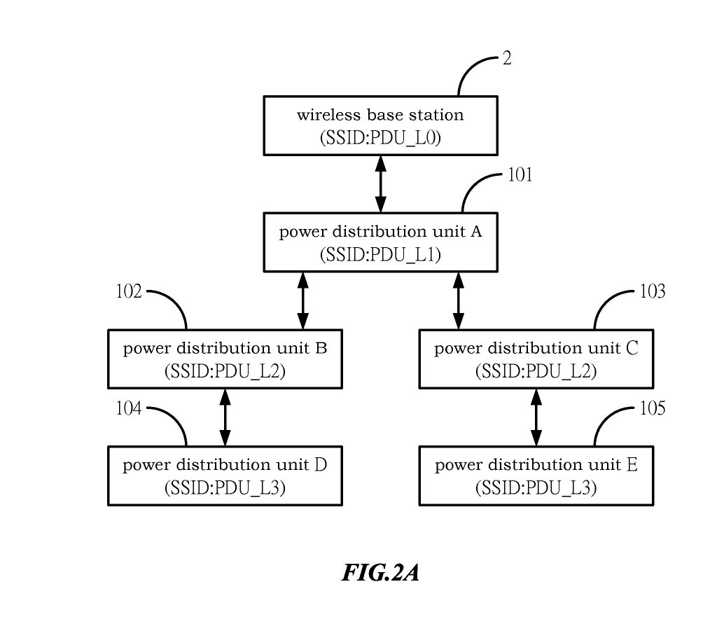

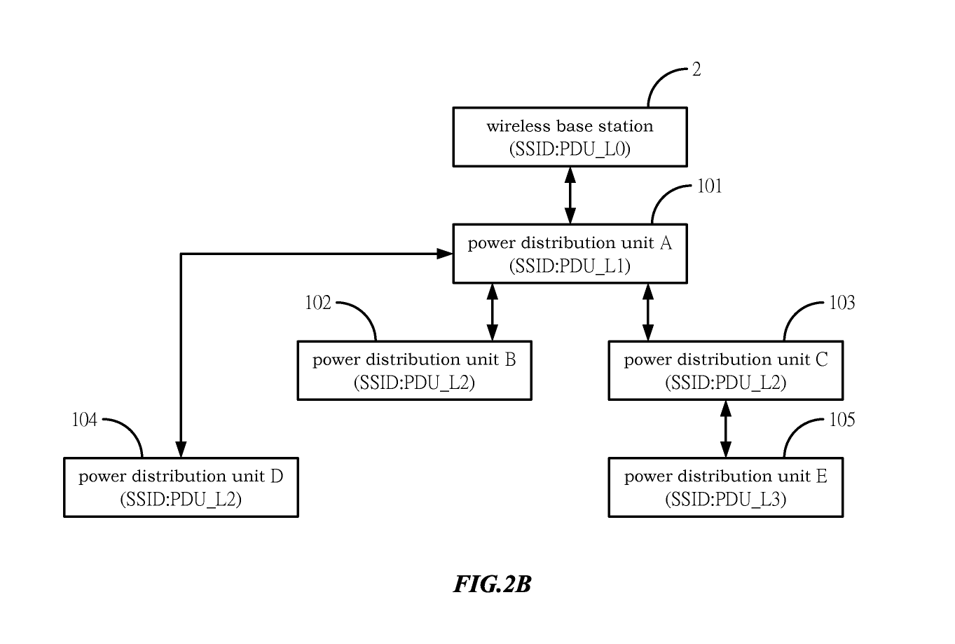

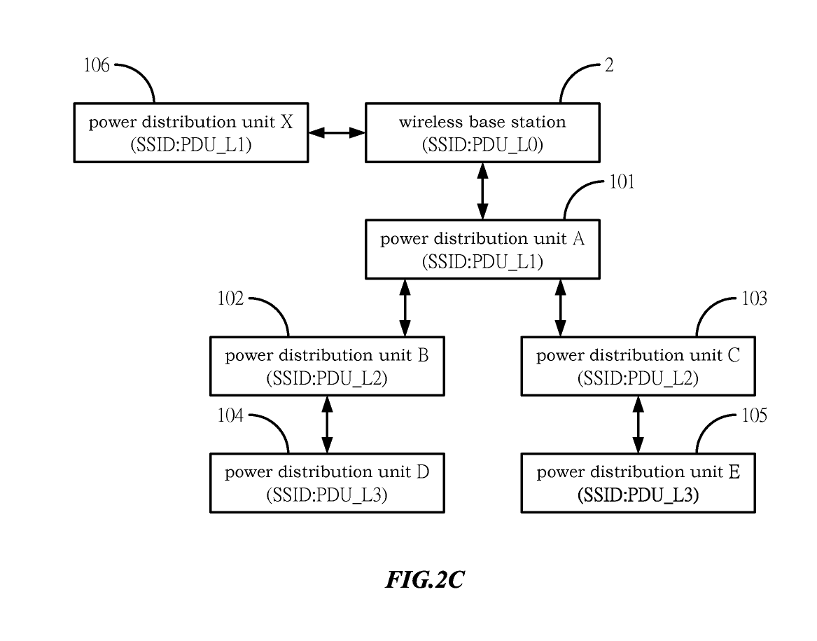

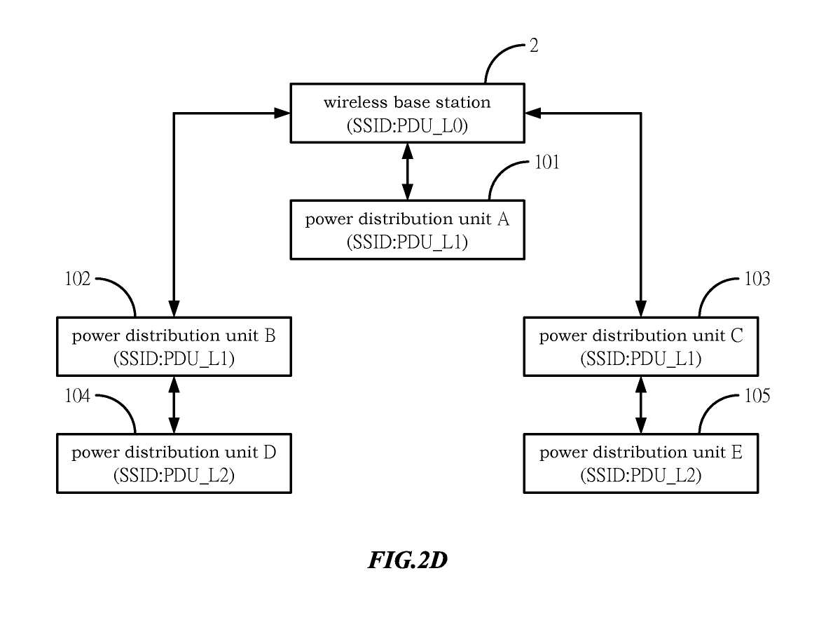

As shown in FIG. 2A, which is a first preferred embodiment of physically distributing the network topology. While the power outlet control device A101 connects with the wireless base station 2, the power outlet control device A 101 may automatically change the service set identifier (SSID) to a specific characteristic string, so that other power outlet control device can recognize that the power outlet control device A101 has been set up and has successfully been connected with the Internet. As shown in figure, the power outlet control device A101 may change the service set identifier to PDU_L1. Meanwhile, the power outlet control device A101 may allow other power outlet control device to connect with.

The power outlet control device B102, the power outlet control device C103 are the next level of connections. Hence, the service set identifier is automatically changed to PDU_L2. The next level of connections are the power outlet control device D 104 and the power outlet control device D105. While the up connection is finished, the service set identifier will be changed to PDU_L3.

As aforesaid connections, the power outlet control device may automatically search a network sharing device, such as a wireless base station or another power outlet control device, nearby, and chooses the smallest node and the node with the strongest signal to be judgements for determining connection. In addition, as shown in FIG. 2B, if one of the power outlet control device cannot be disconnected, that is, while the power outlet control device D104 determines that the last level of the power outlet control device B102 is out of order, a nearest network sharing device that can be connected will be searched. As shown in figure, the last determination is that the shortest distance is the power outlet control device A101. Hence, the power outlet control device A101 will be connected with and the service set identifier is changed to PDU_L2.

More, while a new power outlet control device X106 is added, as shown in FIG. 2C, a nearest network sharing device that can be connected will be searched. As shown in figure, the last determination is that the shortest distance is the wireless base station 2. Hence, the wireless base station 2 will be connected with and the service set identifier is changed to PDU_L1.

More, as shown in FIG. 2D, while a power outlet control device disconnects with a wireless base station, devices connecting with the power outlet control device will be affected. Since the power outlet control device A101 disconnects and cannot engage in wireless hotspot network share, the power outlet control device B102, the power outlet control device C103, the power outlet control device D104, and the power outlet control device E105 may re-search the nearest network sharing devices that can be connected with. As shown in figure, the power outlet control device B102 and the power outlet control device C103 connect with the wireless base station, the service set identifier is changed to PDU_L1. After connection, the power outlet control device D104 and the power outlet control device E105 respectively re-connect with the power outlet control device B102 and the power outlet control device C103, and the service set identifier is changed to PDU_L2.

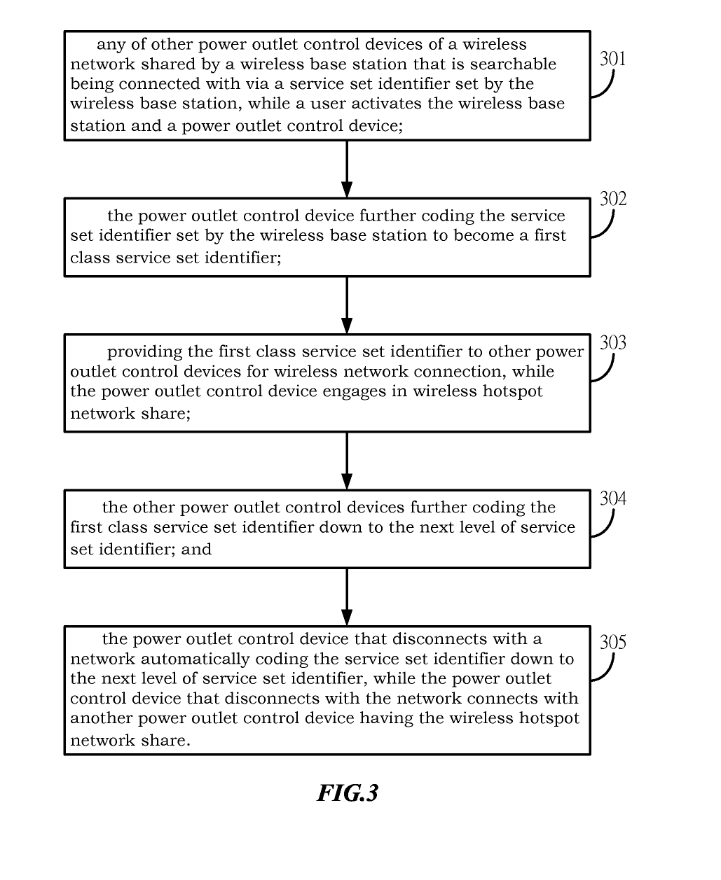

According to aforesaid, as shown in FIG. 3, the method for distributing the power outlet control device of the wireless network topology of the present invention has the steps of:
(S301) any of other power outlet control devices of a wireless network shared by a wireless base station that is searchable being connected with via a service set identifier set by the wireless base station, while a user activates the wireless base station and a power outlet control device;
(S302) the power outlet control device further coding the service set identifier set by the wireless base station to become a first class service set identifier;
(S303) providing the first class service set identifier to other power outlet control devices for wireless network connection, while the power outlet control device engages in wireless hotspot network share;
(S304) the other power outlet control devices further coding the first class service set identifier down to the next level of service set identifier; and
(S305) the power outlet control device that disconnects with a network automatically coding the service set identifier down to the next level of service set identifier, while the power outlet control device that disconnects with the network connects with another power outlet control device having the wireless hotspot network share.

Compared to prior arts, the power distribution unit for the wireless network topology and the distribution method thereof provided by the present invention has following advantages listed below:
1. The present invention is able to let a plurality of PDUs be connected with each other through wireless network communication means. While a PDU is set up and connect with the Internet, the PDU becomes a new wireless network hotspot of a home. While another PDU appears, the another PDU may automatically connect with the Internet through the new wireless network hotspot of the first PDU, so as to easily distribute the wireless network topology.
2. The present invention is able to use present PDUs in order to easily distribute the wireless network topology.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A power distribution unit for a wireless network topology comprising:
a power input interface unit, which connects with an outer power source for providing power;
a power switch control unit, which connects with the power input interface unit for distributing and control the power from the input interface unit;
a wireless network interface unit, which at least connects with an network sharing device with a service set identifier;
a central process unit, which connects with the power switch control unit and the wireless network interface unit, the central process unit comprising:
an automatic searching network module, which connects with the wireless network interface unit for searching the network sharing device around the power distribution unit and driving the wireless network interface unit to connect with the network sharing device nearest the wireless network interface unit;
a coding control module, which connects with the automatic searching network module for coding the service set identifier of the network sharing device that connects with the wireless network interface unit;
a wireless network sharing module, which connects with the wireless network interface unit and the coding control module, the wireless network sharing module treating the coded service set identifier as a wireless network identifier, and making the power distribution unit to engage in wireless hotspot network share through the wireless network interface unit;
a disconnection judgment module, which connects with the wireless network interface unit and the automatic searching network module in order to determine whether the wireless network interface unit continuously engages in wireless connection, if no, the automatic searching network module being driven to search and connect with the network sharing device around the automatic searching network module;
a memory unit, which connects with the central process unit and is able to store data information set by the central process unit; and
a power output unit, which connects with the power switch control unit in order to output power to an outer system and control the power of the outer system.

2. The power distribution unit for the wireless network topology according to claim 1 further comprising a time counting unit, which connects with the central process unit for controlling a power output time and an automatic disconnection redetection time.

3. The power distribution unit for the wireless network topology according to claim 1, wherein the wireless network sharing module having the coded service set identifier is a wireless base station or other power distribution units.

4. The power distribution unit for the wireless network topology according to claim 3, wherein the wireless base station is able to connect with an outer network.

5. The power distribution unit for the wireless network topology according to claim 4 further comprising a remote control device that connects with the wireless base station and the power distribution unit for remote control through the outer network.

6. The power distribution unit for the wireless network topology according to claim 1 further engaging in the wireless hotspot network share and searching the shared wireless network via other power distribution unit, and connecting with the wireless network identifier through a coded service set identifier.

7. A method for distributing a wireless network topology comprising the steps of:
any of other power distribution units of a wireless network shared by a wireless base station that is searchable being connected with via a service set identifier set by the wireless base station, while a user activates the wireless base station and a power distribution unit;
the power distribution unit further coding the service set identifier set by the wireless base station to become a first class service set identifier;
providing the first class service set identifier to other power distribution units for wireless network connection, while the power distribution unit engages in wireless hotspot network share;
the other power distribution units further coding the first class service set identifier down to the next level of service set identifier; and
the power distribution unit that disconnects with a network automatically coding the service set identifier down to the next level of service set identifier, while the power distribution unit that disconnects with the network connects with another power distribution unit having the wireless hotspot network share.

8. The method for distributing a wireless network topology according to claim 7, wherein if the power distribution unit connecting with a network detects the disconnection of the power distribution unit and the network, the power distribution unit automatically search the wireless base station or the power distribution unit around, and codes the service set identifier set by the connected wireless base station or the connected power distribution unit down to the next level of service set identifier.
